(19) United States
(12) Patent Application Publication
(10) Pub. No.: US 2010/0045519 A1
(43) Pub. Date: Feb. 25, 2010

(54) METHOD OF RECORDING POSITION OF MOBILE DEVICE, MOBILE DEVICE AND RECORDING MEDIUM THEREOF

(75) Inventor: Moon-sang LEE, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/418,762

(22) Filed: Apr. 6, 2009

(30) Foreign Application Priority Data
Aug. 22, 2008 (KR) 2008-82369

(51) Int. Cl. G01S 1/00

(52) U.S. Cl. 342/357.09

(57) ABSTRACT

A method of recording the position of a mobile device, wherein the method is used to reduce power consumption, a mobile device having a position recording function, and a recording medium having embodied thereon a program for executing the method. The method includes calculating a moving speed of the mobile device; if the moving speed is not higher than a first speed, decreasing the frequency of recording of position information of the mobile device; if the moving speed is higher than the first speed, increasing the frequency of recording of position information of the mobile device; and if the moving speed is higher than the first speed and not higher than a second speed, exponentially-changing the frequency of recording of the position information of the mobile device according to the moving speed of the mobile device.

### CROSS-REFERENCE TO RELATED APPLICATIONS

This application claims the benefit of Korean Patent Application No. 2008-82369, filed in the Korean Intellectual Property Office on Aug. 22, 2008, the disclosure of which is incorporated herein in its entirety by reference.

### BACKGROUND OF THE INVENTION

1. Field of the Invention

Aspects of the present invention relate to a method of recording the position of a mobile device, a mobile device having a position recording function, and a recording medium having embodied thereon a program for executing the method.

2. Description of the Related Art

Recently, mobile devices having a global positioning system (GPS) function for recording position information of the mobile devices have been released. The GPS is a position-tracking system that can track the position of an object that has stopped or is moving by receiving information from a satellite in any place on earth. Accordingly, mobile devices having a GPS function can track and record their present position. However, mobile devices using a battery, such as mobile phones or personal digital assistants (PDAs), require algorithms capable of recording accurate position information and efficiently controlling power.

### SUMMARY OF THE INVENTION

Aspects of the present invention provide a method of recording the position of a mobile device, wherein the method is used to reduce power consumption, a mobile device having a position recording function, and a recording medium having embodied thereon a program for executing the method.

According to an aspect of the present invention, a method of recording the position of a mobile device is provided. The method includes calculating a moving speed of the mobile device; decreasing the frequency of recording position information of the mobile device if the moving speed is not higher than a first speed; increasing the frequency of recording of position information of the mobile device if the moving speed is higher than the second speed; and changing the frequency of the recording of the position information exponentially according to the moving speed of the mobile device if the moving speed is higher than the first speed and not higher than the second speed.

According to another aspect of the present invention, the increasing, the decreasing, and the exponentially changing of the frequency of recording of the position information are performed by adjusting a first period to determine whether the position information of the mobile device is recorded.

According to another aspect of the present invention, the method includes receiving an interrupt signal before calculating the moving speed of the mobile device; if the interrupt signal is received after a prior interrupt signal of the interrupt signal is received, determining whether a period of time corresponding to the first period has passed; and if a period of time corresponding to the first period has passed, recording the position information of the mobile device.

According to another aspect of the present invention, the interrupt signal is received every second period, and the second period is a constant period of time.

According to another aspect of the present invention, the decreasing of the frequency of recording of the position information includes turning off a position information receiving function and a position information recording function of the mobile device if the moving speed is not higher than the first speed; and after the functions are turned-off, recalculating the moving speed by turning-on the functions when the first period has passed, turning off the position information receiving and the position information recording functions and maintaining a wait state for the first period if the recalculated moving speed is not higher than the first speed, and recording the position information of the mobile device and changing the first period if the recalculated moving speed is higher than the first speed.

According to another aspect of the present invention, the position information is based on global positioning system (GPS) coordinates.

According to another aspect of the present invention, a mobile device is provided. The mobile device includes: a position information receiving unit to receive present position information of the mobile device through a network; a storing unit to store the position information; and a controlling unit to calculate a moving speed of the mobile device based on the present position information and prior position information of the mobile device, and to control the position information to be recorded in the storing unit; wherein, if the calculated moving speed is higher than a first speed and not higher than a second speed, the controlling unit changes the frequency of the recording of the position information exponentially according to the moving speed of the mobile device.

According to another aspect of the present invention, the controlling unit changes the frequency of recording exponentially by adjusting a first period to determine whether the position information of the mobile device is recorded.

According to another aspect of the present invention, the mobile device further includes a timer interrupt signal generating unit to periodically generate a timer interrupt signal to transfer the timer interrupt signal to the controlling unit; wherein, whenever the timer interrupt signal is received, the controlling unit determines whether a period of time corresponding to the first period has passed after receiving the prior timer interrupt signal, and if a period of time corresponding to the first period has passed, the controlling unit controls the position information of the mobile device to be recorded in the storing unit.

According to another aspect of the present invention, the controlling unit controls the position information to be recorded in the storing unit by decreasing the frequency of the recording of the position information if the calculated moving speed is not higher than the first speed, and increasing the frequency of the recording of the position information if the calculated moving speed is higher than the second speed.

According to another aspect of the present invention, the controlling unit turns off power supplied to the position information receiving unit and the storing unit if the moving speed is not higher than the first speed; recalculates the moving speed of the mobile device by turning-on power supplied to the position information receiving unit and the storing unit if a period of time corresponding to the first period has passed after turning off the power; turns off power supplied to the position information receiving unit and the storing unit and maintain a wait state for a period of time corresponding to the first period if the recalculated moving speed is not higher than the first speed; and controls the position information to be recorded in the storing unit and changes the first period if the recalculated moving speed is higher than the first speed.

According to another aspect of the present invention, the position information receiving unit includes a GPS receiving unit.

According to another aspect of the present invention, there is provided a computer readable recording medium having embodied thereon a computer program to execute a method of recording a mobile device as described above.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating a function of a mobile device according to an embodiment of the present invention;

FIG. 2 is a graph of a first period function for recording position information, according to an embodiment of the present invention;

FIG. 3 is a flowchart of a method of recording the position of a mobile device, according to an embodiment of the present invention;

FIG. 4 is a flowchart of another method of recording the position of a mobile device, according to another embodiment of the present invention; and

FIGS. 5A and 5B are flowcharts of still another method of recording the position of a mobile device, according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Exemplary embodiments according to the present invention will be described in detail with reference to the accompanying drawings.

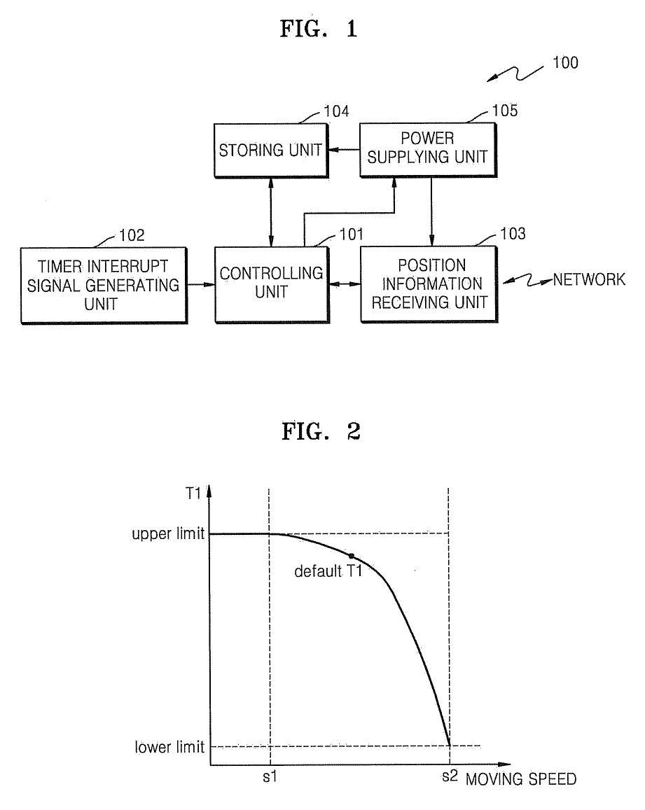

FIG. 1 is a block diagram illustrating a function of a mobile device 100 according to an embodiment of the present invention. The mobile device 100 includes a controlling unit 101, a timer interrupt signal generating unit 102, a position information receiving unit 103, a storing unit 104, and a power supplying unit 105. According to other aspects of the present invention, the mobile device 100 may include additional and/or different units. Similarly, the functionality of two or more of the above units may be integrated into a single component. The mobile device 100 may be an apparatus using a battery, such as a mobile phone, a personal digital assistant (PDA), a portable multimedia system, etc., or may be a navigation system installed in a moving system such as a vehicle, a plane, a ship, etc.

The controlling unit 101 controls functions of the mobile device 100. For example, the controlling unit 101 calculates a moving speed of the mobile device 100 in order to record position information of the mobile device 100 in the storing unit 104.

Whenever a timer interrupt signal is received, the controlling unit 101 determines whether a period of time corresponding to a first period T1 has passed since a prior timer interrupt signal was received. The first period T1 is a period for determining whether the position information of the mobile device 100 is recorded. The first period T1 may use a default value, but may also vary according to the moving speed of the mobile device 100.

The timer interrupt signal generating unit 102 generates a timer interrupt signal every second period T2. The second period T2 may be a constant period. When the power of the mobile device 100 is turned on, the first period T1 and the second period T2 may have the same value. The first period T1 may vary according to the movement of the mobile device 100; the second period T2, however, may remain constant.

When the time corresponding to the first period T1 has passed, the controlling unit 101 calculates a moving speed of the mobile device 100 using the present position information and prior position information of the mobile device 100. The controlling unit 101 may record the present position information received through the position information receiving unit 103 in the storing unit 104.

The position information includes position data and a receiving time of the position data. The controlling unit 101 detects a difference ΔP between present position information P1 and prior position information P2 as (P1−P2=ΔP). The difference ΔP between the detected position data is a moving distance Δd of the mobile device 100.

The controlling unit 101 then detects a difference Δt between a receiving time t1 included in the present position information P1 and a receiving time t2 included in the prior position information P1 (t1−t2=Δt). The difference Δt between the detected receiving times is the time in which the mobile device 100 moves the moving distance Δd.

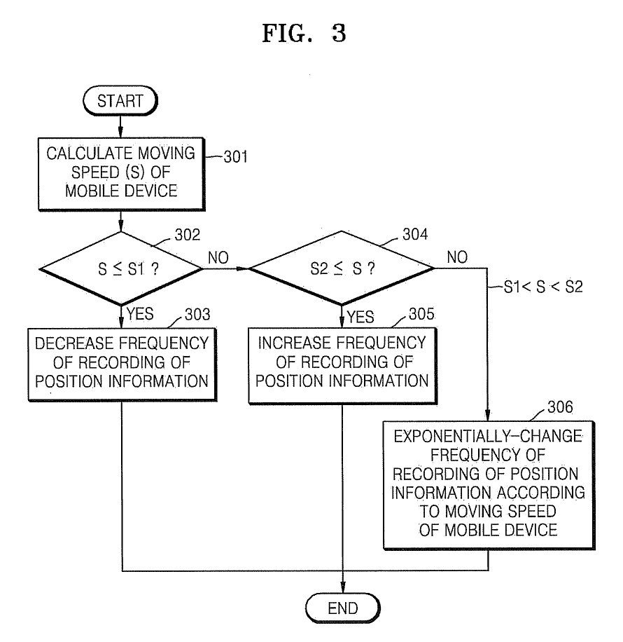

The controlling unit 101 calculates a moving speed (S=Δd/Δt) of the mobile device 100 by dividing the moving distance Δd by the difference Δt between the receiving times. When the moving speed S of the mobile device 100 is calculated, the controlling unit 101 compares the calculated moving speed S with previously established first and second speeds S1 and S2. The first and second speeds S1 and S2 may have values as shown in FIG. 2.

FIG. 2 is a graph of a first period T1 function for recording position information, according to an embodiment of the present invention. As shown in FIG. 2, a first speed S1 has a value based on a speed where the mobile device 100 hardly moves, and a second speed S2 has a value based on a high speed of the mobile device 100. The values of the first speed S1 and the second speed S2 may be experimentally determined based on operation conditions of the mobile device 100.

As a result of the comparison between the calculated speed S and the first and second speeds S1 and S2, when the calculated speed S is not higher than the first speed S1, the controlling unit 101 may control the mobile device 100 so that the frequency (or the number of times) of recording of position information of the mobile device 101 is decreased. For example, the controlling unit 101 may decrease the frequency in which the position information of the mobile device 101 is recorded by lengthening the first period T1. If a larger value of the first period T1 than a currently established value of the first period T1 is established, the first period T1 is lengthened. Accordingly, when the mobile device 100 does not move for hours, the position information recorded in the storing unit 104 decreases, thereby reducing power consumption according to the recording of the position information and increasing the capability of the storing unit 104.

If the calculated moving speed S is not higher than the first speed S1, the controlling unit 101 may control the power supplied to the position information receiving unit 103 and the storing unit 104 to be turned off. While the power supplied to the position information receiving unit 103 and the storing unit 104 is turned off, the controlling unit 101 determines whether the time corresponding to the first period T1 has passed. If a period of time corresponding to the first period T1 has passed, the controlling unit 101 may control power supplied to the position information receiving unit 103 and the storing unit 104 to be turned on and control the position information received from the position information receiving unit 103 to be recorded in the storing unit 104, and then recalculate a moving speed of the mobile device 100.

If a recalculated moving speed S′ is not higher than the first speed S1, the controlling unit 101 turns off power supplied to the position information receiving unit 103 and the storing unit 104 and maintains a wait state for the first period T1. While the position information receiving unit 103 and the storing unit 104 are not used, power supplied to the position information receiving unit 103 and the storing unit 104 is turned off, thereby reducing power consumption of the mobile device 100.

If the recalculated moving speed S′ is higher than the first speed S1, the controlling unit 101 records the position information received from the position information receiving unit 103 in the storing unit 104 and changes the first period T1. The first period T1 may be changed so that the frequency of recording of the position information changes exponentially, as will be described later.

When the moving speed S or the recalculated moving speed S′ is higher than the first speed S1 and lower than the second speed S2, the controlling unit 101 may change the first period T1 according to the moving speed of the mobile device 100 and the frequency of recording of the position information. As shown in FIG. 2, when the moving speed S or the recalculated moving speed S′ is higher than the first speed S1 and lower than the second speed S2, the controlling unit 101 may change the first period T1 so that the frequency of recording of the position information changes exponentially. When the moving speed S or the recalculated moving speed S′ is higher than the first speed S1 and lower than the second speed S2, the value of the exponentially-changed first period T1 is written in a table form, and the value of the exponentially-changed first period T1 is included in the controlling unit 101 or in the exterior of the controlling unit 101 so that the controlling unit 101 may refer to the value whenever necessary.

If the moving speed S is higher than the second speed S2, the controlling unit 101 may control the mobile device 100 so that the frequency of recording of the position information of the mobile device 100 is increased. For example, the controlling unit 101 may increase the frequency of recording of the position information of the mobile device 100 by shortening the first period T1. When a smaller value of the first period T1 than a currently established value of the first period T1 is established, the first period T1 is shortened. Accordingly, when the moving speed of the mobile device 100 is fast, more accurate position information may be recorded in the storing unit 104 by increasing the amount of position information recorded.

As shown in FIG. 2, a value of the first period T1 is established according to the moving speed S of the mobile device 100. In particular, by establishing an upper limit and a lower limit in the first period T1, the value of the first period T1 may be prevented from being 0 or diverging. In FIG. 2, a default T1 is a value of the first period T1 established by default in the mobile device 100 and may be used when power is turned-on.

The position information receiving unit 103 may receive position information through a network, and may be a global positioning system (GPS) receiving unit. Accordingly, the position information may be based on GPS coordinates.

The storing unit 104 stores the position information of the mobile device 100 recorded by the controlling unit 101, and thus stores at least the position information of the mobile device 100. The storing unit 104 may be a flash memory, although the storing unit 104 is not limited thereto. The storing unit 104 may store a mapping table between the aforementioned moving speed S or recalculated moving speed S′ and the first period T1. The power supplying unit 105 may be controlled by the controlling unit 101 and turn on or turn off power supplied to the storing unit 104 and the position information receiving unit 103.

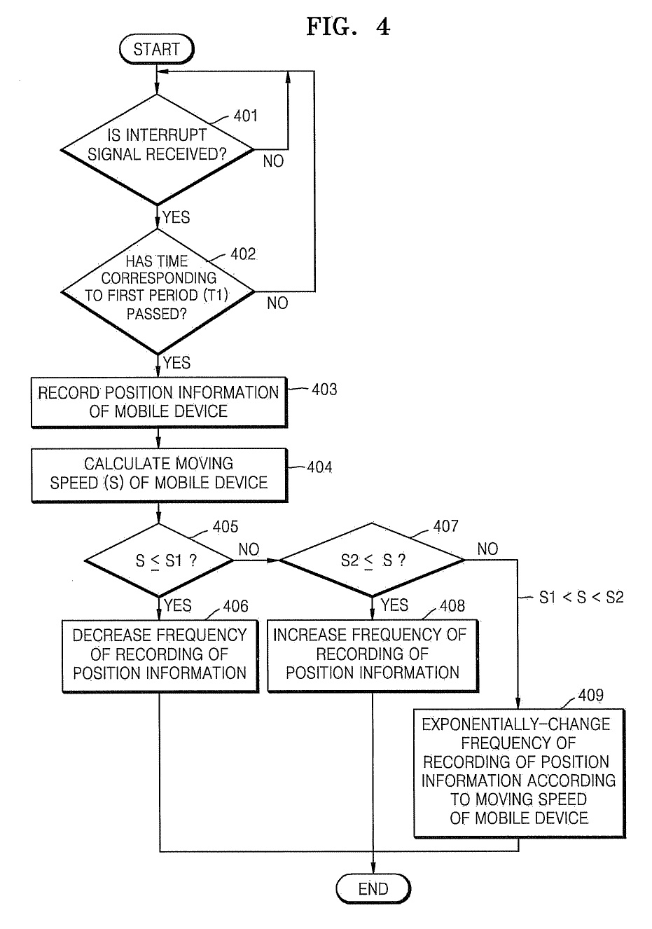

FIG. 3 is a flowchart of a method of recording the position of the mobile device 100, according to an embodiment of the present invention. In operation 301, a moving speed S of the mobile device 100 is calculated. The moving speed S of the mobile device 100 may be calculated as described with respect to FIG. 1. If the moving speed S is not higher than a first speed S1 in operation 302, the frequency of recording of the position information of the mobile device 100 is decreased in operation 303.

If the moving speed S is higher than a second speed S2 in operation 304, the frequency of recording of the position information of the mobile device 100 is increased in operation 305. If the moving speed S is higher than the first speed S1 and lower than the second speed S2 in operation 304, the frequency of recording of the position information of the mobile device 100 changes exponentially according to the moving speed of the mobile device 100 in operation 306. Operations 303, 305, and 306 may be performed by adjusting the first period T1 for determining whether the position information of the mobile device 100 is recorded, as described with respect to FIG. 1.

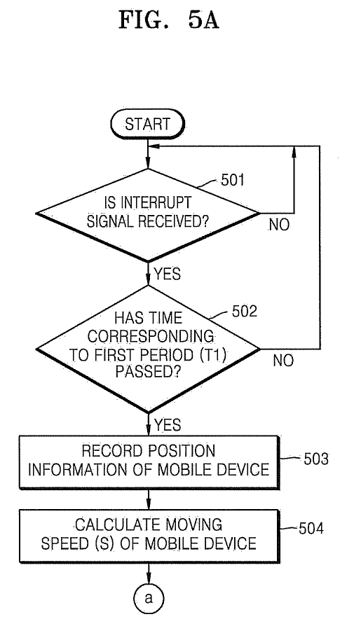

FIG. 4 is a flowchart of another method of recording the position of a mobile device, according to another embodiment of the present invention. Referring to FIG. 4, Operations 404 through 409 of FIG. 4 are similar to Operations 301 through 306 of FIG. 3. The process of FIG. 4 further includes an operation for receiving an interrupt signal, and for recording the position information of the mobile device 100 by the received interrupt signal, before calculating the moving speed S of the mobile device 100, as in the embodiment described with reference to FIG. 3.

Referring to FIG. 4, the interrupt signal is received in operation 401. The interrupt signal may be generated in a similar manner to the timer interrupt signal described with reference to FIG. 1. The interrupt signal may be received every second period T2, which may have a constant period. The relationship between the first period T1 and the second period T2 is as explained with reference to FIG. 1. When the interrupt signal is received, whether time corresponding to the first period T1 has passed since the prior interrupt signal of the interrupt signal is received is determined in operation 402.

If the time corresponding to the first period T1 has passed, position information of the mobile device 100 is recorded in operation 403. Then, operations 404 through 409 are performed in a similar manner to operations 301 through 306 of FIG. 3.

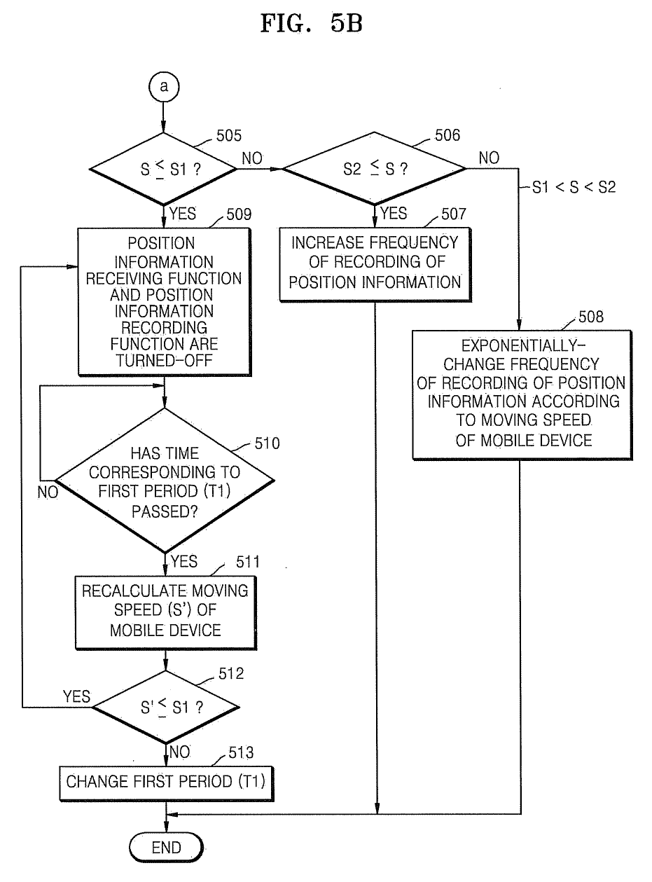

FIG. 5 is a flowchart of still another method of recording the position of a mobile device, according to another embodiment of the present invention. Operations 501 through 508 of FIG. 5 are similar to operations 401 through 405 and 407 through 409 of FIG. 4. The process of FIG. 5 differs from that of the process of FIG. 4 when the moving speed S is not higher than the first speed S1.

When the moving speed S is not higher than the first speed S1, a position information receiving function and a position information recording function of the mobile device are turned off in operation 509. After the functions are turned off, if the time corresponding to the first period T1 has passed in operation 510, the functions are turned on, and the moving speed is recalculated in operation 511.

If the recalculated moving speed S′ is not higher than the first speed S1, the functions are turned off, and a wait state is maintained for the first period T1 in operations 512, 509 and 510. If the recalculated moving speed S′ is higher than the first speed S1, the position information of the mobile device 100 is recorded in the storing unit 104, and the first period T1 is changed in operation 513, as explained with reference to FIG. 1.

The position information of FIGS. 3 through 5 may be based on GPS coordinates.

Aspects of the present invention can also be embodied as computer readable codes on a computer readable recording medium. The computer readable recording medium is any data storage device that can store data that can be thereafter read by a computer system. Examples of the computer readable recording medium include read-only memory (ROM), random-access memory (RAM), CDs, DVDs, Blu-ray discs, magnetic tapes, floppy disks, and optical data storage devices. Additional aspects of the present invention may be distributed over network coupled computer systems so that the computer readable code is stored and executed in a distributed fashion.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of recording the position of a mobile device, the method comprising:
calculating a moving speed of the mobile device;
decreasing a frequency of recording position information of the mobile device if the moving speed is not higher than a first speed;
increasing the frequency of the recording of the position information if the moving speed is higher than a second speed; and
changing the frequency of the recording of the position information exponentially based on the moving speed of the mobile device, if the moving speed is higher than the first speed and not higher than the second speed.

2. The method of claim 1, wherein the increasing, the decreasing and the exponentially changing of the frequency of recording of the position information are performed by adjusting a first period to determine whether the position information of the mobile device is recorded.

3. The method of claim 2 further comprising:
receiving an interrupt signal before calculating the moving speed of the mobile device;
if the interrupt signal is received after a prior interrupt signal of the interrupt signal is received, determining whether a period of time corresponding to the first period has passed; and
if the period of time corresponding to the first period has passed, recording the position information of the mobile device.

4. The method of claim 3, wherein:
the interrupt signal is received each second period; and
the second period is a constant period of time.

5. The method of claim 2, wherein the decreasing of the frequency of the recording of the position information of the mobile device comprises:
turning off a position information receiving function and a position information recording function of the mobile device if the moving speed is not higher than the first speed;
after the functions are turned off:
when the first period has passed, recalculating the moving speed by turning-on the functions;
if the recalculated moving speed is not higher than the first speed, turning off position information receiving and position information recording functions of the mobile device and maintaining a wait state for the first period; and
if the recalculated moving speed is higher than the first speed, recording the position information of the mobile device and changing the first period.

6. The method of claim 5, wherein the position information is based on global positioning system (GPS) coordinates.

7. The method of claim 1, wherein the position information is based on global positioning system (GPS) coordinates.

8. A mobile device comprising:
a position information receiving unit to receive present position information of the mobile device through a network;
a storing unit to store the position information; and
a controlling unit to calculate a moving speed of the mobile device based on the present position information and prior position information of the mobile device and to control the position information to be recorded in the storing unit;
wherein, if the calculated moving speed is higher than a first speed and not higher than a second speed, the controlling unit changes the frequency of the recording of the position information exponentially according to the moving speed of the mobile device.

9. The mobile device of claim 8, wherein the controlling unit changes the frequency of recording exponentially by adjusting a first period to determine whether the position information of the mobile device is recorded.

10. The mobile device of claim 9, further comprising:
a timer interrupt signal generating unit to periodically generate a timer interrupt signal to transfer the timer interrupt signal to the controlling unit,
wherein, whenever the timer interrupt signal is received, the controlling unit determines whether a period of time corresponding to the first period has passed after receiving the prior timer interrupt signal, and if a period of time corresponding to the first period has passed, the controlling unit controls the position information of the mobile device to be recorded in the storing unit.

11. The mobile device of claim 8, wherein the controlling unit controls the position information to be recorded in the storing unit by decreasing the frequency of the recording of the position information if the calculated moving speed is not higher than the first speed, and increasing the frequency of the recording of the position information if the calculated moving speed is higher than the second speed.

12. The mobile device of claim 9, wherein the controlling unit:
turns off power supplied to the position information receiving unit and the storing unit if the moving speed is not higher than the first speed;
recalculates the moving speed of the mobile device by turning on power supplied to the position information receiving unit and the storing unit, if a period of time corresponding to the first period has passed after turning off the power;
turns off power supplied to the position information receiving unit and the storing unit and maintains a wait state for a time corresponding to the first period, if the recalculated moving speed is not higher than the first speed; and
controls the position information to be recorded in the storing unit and changes the first period, if the recalculated moving speed is higher than the first speed.

13. The mobile device of claim 8, wherein the position information receiving unit comprises a global positioning system (GPS) receiving unit.

14. A computer readable recording medium having embodied thereon a computer program to execute a method of recording a mobile device, the method comprising:
calculating a moving speed of the mobile device;
decreasing the frequency of recording position information of the mobile device if the moving speed is not higher than a first speed;
increasing the frequency of the recording of the position information, if the moving speed is higher than a second speed; and
if the moving speed is higher than the first speed and not higher than the second speed, exponentially changing the frequency of the recording of the position information according to the moving speed of the mobile device.

15. The computer readable recording medium of claim 14, wherein the decreasing, the increasing, and the exponentially changing of the frequency of the recording of the position information are each performed by adjusting a first period to determine whether the position information of the mobile device is recorded.

16. The computer readable recording medium of claim 15, wherein the recording of the position of the mobile device further comprises:
before calculating a moving speed of the mobile device, receiving an interrupt signal;
if the interrupt signal is received, determining whether a period time corresponding to the first period has passed since a prior interrupt signal was received; and
if a period of time corresponding to the first period has passed, recording the position information of the mobile device.

17. The computer readable recording medium of claim 16, wherein:
the interrupt signal is received each second period; and
the second period has a constant period.

18. The computer readable recording medium of claim 15, wherein the decreasing of the frequency of recording of the position information of the mobile device comprises:
if the moving speed is not higher than a first speed, turning off a position information receiving function and a position information recording function of the mobile device;
after the position information receiving and the position information recording functions are turned off:
when the first period has passed, recalculating the moving speed by turning on the position information receiving function and the position information recording function;
if the recalculated moving speed is not higher than the first speed, turning off the position information receiving and the position information recording functions and maintaining a wait state for the first period; and
if the recalculated moving speed is higher than the first speed, turning on the position information receiving and the position information recording functions, recording the position information of the mobile device, and changing the first period.

19. The computer readable recording medium of claim 18, wherein the position information is based on global positioning system (GPS) coordinates.

20. A method of reducing power consumption when recording a position of a mobile device, the method comprising:
calculating a moving speed of the mobile device; and
repeatedly recording position information of the mobile device;
wherein:
a frequency in which the position information is recorded is decreased if the moving speed is less than or equal to a first speed;
the frequency in which the position information is recorded increased if the moving speed is greater than a second speed; and
the frequency in which the position information is recorded is changed exponentially based on the calculated moving speed, if the moving speed is greater than the first speed and less than or equal to the second speed.

21. The method of claim 21, further comprising:
increasing, decreasing, or exponentially changing the frequency in which the position information is recorded based on the calculated moving speed each time a first time period elapses.

22. The method of claim 22, further comprising:
receiving an interrupt signal whenever a second period of time elapses;
after receiving the interrupt signal, determining whether the first time period has elapsed since the previous interrupt signal was received; and
recording the position information if the first time period has elapsed since the previous interrupt signal was received.

23. The method of claim 21, further comprising:
adjusting a value of the first time period so as to exponentially change the frequency in which the position information is recorded.

24. The method of claim 21, wherein, whenever a second time period elapses, the frequency in which the position information is recorded is increased, decreased, or changed exponentially if the first time period has elapsed.
